(19) United States
(12) Patent Application Publication
(10) Pub. No.: US 2026/0259183 A1
(43) Pub. Date: Sep. 3, 2026

(54) METASTABLE IONISATION AND EMISSION DETECTOR, AND RELATED METHODS

(71) Applicant: 9518-1236 QUEBEC INC., Thetford Mines (CA)

(72) Inventor: Yves GAMACHE, Thetford Mines (CA)

(21) Appl. No.: 18/873,411

(22) PCT Filed: Jun. 9, 2023
(86) PCT No.: PCT/CA2023/050797

§ 371 Date: Dec. 10, 2024

Related U.S. Application Data
(60) Provisional application No. 63/366,168, filed on Jun. 10, 2022.

(51) Int. Cl. G01N 30/64; G01N 30/02; G01N 30/16; G01N 30/74; G01N 30/84

(52) U.S. Cl. CPC G01N 30/64; G01N 30/16; G01N 30/74; G01N 30/84; G01N 2030/025; G01N 2030/8482

(57) ABSTRACT

The present disclosure relates to techniques for exciting and/or ionizing analyte(s) in a sample without exciting and/or ionizing the non-analyte(s). The techniques allow eliminating or at least reducing the relatively strong emission generally associated with the non-analyte(s) or background. The system includes a metastable species source, which includes a plasma chamber, a plasma discharge mechanism and a conduit. The conduit includes an electrically-conductive region adapted to receive the electrically-charged species and allow circulation of the metastable species. The system also includes a measurement chamber configured to receive a sample from a chromatography method and receive the metastable species after circulation of the plasma in the conduit. An interaction between the metastable species and the sample produces an excited or ionized analyte, without exciting or ionizing non-analyte present in the sample. The system also includes a detector configured to obtain a sample chromatogram from the excited or ionized analyte.

### TECHNICAL FIELD

The technical field generally relates to gas chromatography techniques, and more particularly to a metastable ionization and emission detector, as well as related systems and methods.

### BACKGROUND

Examples of standard optical emission spectroscopy techniques include inductively coupled plasma (ICP) spectroscopy, microwave spectroscopy, dielectric barrier discharge (DBD) based spectroscopy, and direct current (DC) discharge based spectroscopy. One drawback associated with these techniques is that the entirety of the sample, including the background and the impurity, is excited and ionized. Results obtained using such techniques therefore typically include an important noise component, because of the presence a strong and dominant background emission, which may produce physical and chemical interferences with the actual signal to be detected or monitored.

In chromatography applications, other types of detectors are typically used. An example of a chromatography detector is a windowless helium photon ionization detector. In such a detector, the dominant impurities ionization process is the photon ionization, followed by the Penning ionization. In some instances, argon gas can be used. However, in applications wherein the background gas is different from the carrier gas, an extra gas chromatography column should be used to vent away the sample background, before it reaches the detector. This configuration is limitative, as it generally requires additional gas chromatography (GC) components, such as valves. Venting the sample background and using valves have a detrimental on the results generated by the detector, notably in terms of peak shape and resolution. These drawbacks are not limited to the technologies mentioned above, but are also present in other types of detectors, such flame ionization detector (FID), electron capture detector (ECD), argon ionization (Al) detector, radio-gas chromatography (RGC) detector, ion mobility spectrometry (IMS) detector, and mass spectroscopy (MS) detector.

Therefore, challenges remain in the field of characterizing a sample using chromatography techniques.

### SUMMARY

The present techniques generally relate to techniques for exciting and/or ionizing analyte(s) in a sample without exciting and/or ionizing the non-analyte(s) (sometimes referred as the “background”). The techniques allow eliminating or at least reducing the relatively strong emission generally associated with the non-analyte(s) or background, which leads to a more precise characterization or measurement of the analytes contained in the sample.

In accordance with one aspect, there is provided a system for chromatographically analyzing a sample, the system including:
a metastable species source, the metastable species source including:
   a plasma chamber having an inlet and an outlet, the inlet being configured to receive a gas stream;
   a plasma discharge mechanism configured to produce a plasma from the gas stream circulating in the plasma chamber, the plasma including at least metastable species and electrically-charged species; and
   a conduit in fluid communication with the outlet of the plasma chamber and adapted to receive the gas from the plasma chamber, the conduit including an electrically-conductive region configured to trap the electrically-charged species and allow circulation of the metastable species;
a measurement chamber configured to:
   receive the sample from a chromatography method, the sample including an analyte and a non-analyte; and
   receive the metastable species after circulation of the gas from the plasma chamber in the conduit, wherein an interaction between the metastable species and the sample produces an excited or ionized analyte, without exciting or ionizing the non-analyte; and
a detector configured to obtain a sample chromatogram from the excited or ionized analyte.

In some embodiments, the gas stream contains a pure gas.

In some embodiments, the gas stream is doped with a reagent or a doping agent.

In some embodiments, the plasma chamber is at least partially made of quartz.

In some embodiments, the plasma discharge mechanism includes two electrodes.

In some embodiments, the two electrodes are flat electrodes positioned in a spaced-apart configuration one from another.

In some embodiments, the plasma chamber has a plurality of sidewalls, and each electrode is mounted on a respective sidewall of the plasma chamber.

In some embodiments, the conduit includes a first segment and a second segment, the first segment forming an angle of about 90° with the second segment.

In some embodiments, the conduit includes a first segment, a second segment, and a bent segment therebetween.

In some embodiments, the conduit has a relatively circular cross-section.

In some embodiments, the conduit is S-shaped.

In some embodiments, the conduit has a zigzag profile.

In some embodiments, the conduit further includes an anodized region to prevent light transmission out of the plasma chamber towards the measurement chamber, the anodized region being located at a different position from the electrically-conductive region.

In some embodiments, at least one portion of the conduit is tapered.

In some embodiments, the electrically-conductive region of the conduit is provided in said at least one portion of the conduit being tapered.

In some embodiments, the metastable species source includes a plurality of plasma chambers, each having a corresponding conduit disposed along an outer surface of the measurement chamber, such that each conduit is radially disposed with respect to the measurement chamber.

In some embodiments, the conduit is substantially perpendicular to the outer surface of the measurement chamber.

In some embodiments, the system further includes an optical shield disposed between the plasma chamber and the measurement chamber.

In some embodiments, the detector is configured to perform an optical detection of the excited or ionized analyte.

In some embodiments, the detector is configured to perform an electrical detection of the excited or ionized analyte.

In some embodiments, the detector is configured to perform both an optical detection and an electrical detection of the excited or ionized analyte.

In some embodiments, the optical detection and the electrical detection are simultaneously performed.

In some embodiments, the optical detection and the electrical detection are sequentially performed.

In some embodiments, obtaining the sample chromatogram associated with the excited or ionized analyte is delayed with respect with generating the metastable species.

In accordance with another aspect, there is provided a method for chromatographically analyzing a sample, the method including:
a plasma chamber, generating a plasma in a gas stream, the plasma including at least metastable species and electrically-charged species;
circulating the plasma in a conduit including an electrically-conductive region adapted to receive and trap the electrically-charged species and allow circulation of the metastable species;
injecting the sample in a measurement chamber, the sample including an analyte and a non-analyte;
injecting the metastable species in the measurement chamber, wherein an interaction between the metastable species and the sample produces an excited or ionized analyte, without exciting or ionizing the non-analyte; and
obtaining a sample chromatogram from the excited or ionized analyte.

In some embodiments, the gas stream contains a pure gas.

In some embodiments, the gas stream is doped with a reagent or a doping agent. In some embodiments, said obtaining the sample chromatogram includes optically detecting the excited or ionized analyte.

In some embodiments, said obtaining the sample chromatogram includes electrically detecting the excited or ionized analyte.

In some embodiments, said obtaining the sample chromatogram includes optically detecting and electrically detecting the excited or ionized analyte.

In some embodiments, said optically detecting and electrically detecting the excited or ionized analyte are simultaneously performed.

In some embodiments, said optically detecting and electrically detecting the excited or ionized analyte are sequentially performed.

In some embodiments, obtaining the sample chromatogram associated with the excited or ionized analyte is delayed with respect with generating the metastable species.

In some embodiments, the method further includes reducing a flow of the gas stream to limit an introduction of electrical charges into the measurement chamber.

In accordance with one aspect, there is provided a detector allowing excitation and ionization of impurities or analytes in a sample background, without ionizing the background itself, thereby preventing the generation of a strong background emission and ionization, which is typically associated with relatively large interferences with impurities or analytes measurement. The detector does not ionize the sample background or the carrier gas, while exciting the impurities in order to generate specific emissions and/or ionizing impurities in order to measure emission and/or ionizing current related to such impurity ionization.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features can be combined with one another unless stated otherwise.

### BRIEF DESCRIPTION OF THE DRAWINGS

FIG. 1 is a schematic of a system for chromatographically analyzing a sample, in accordance with one embodiment.

FIG. 2 illustrates that the measurements or detection of the chromatogram associated with the excited or ionized species can be delayed with respect with the generation or production of the metastable species.

FIGS. 3 to 9 are different views of a system for chromatographically analyzing a sample, in accordance with one embodiment.

FIG. 10 is a cross-section of FIG. 4, taken along the A-A line presented in FIG. 4.

### DETAILED DESCRIPTION

In the present description, similar features in the drawings have been given similar reference numerals. To avoid cluttering certain figures, some elements may not be indicated if they were already identified in a preceding figure. It is appreciated that the elements of the drawings are not necessarily depicted to scale, since emphasis is placed on clearly illustrating the structure and operation of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. It will be understood that such spatially relative terms are intended to encompass different orientations in the use or operation of the present embodiments, in addition to the orientations exemplified in the figures.

In the present description, the terms “a”, “an”, and “one” are defined to mean “at least one”, that is, these terms do not exclude a plural number of elements, unless stated otherwise.

Terms such as “substantially”, “generally”, and “about”, that modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or equivalent function or result). In some instances, the term “about” means a variation of ±10 percent of the stated value. It is noted that all numeric values used herein are assumed to be modified by the term “about”, unless stated otherwise.

Unless stated otherwise, the terms “connected”, “coupled”, and derivatives and variants thereof, refer to any connection or coupling, either direct or indirect, between two or more elements. The connection or coupling between the elements may be, for example, mechanical, optical, electrical, thermal, chemical, fluidic, magnetic, logical, operational, or any combination thereof.

In the present description, the terms “gas sample”, “sample”, synonyms and derivatives thereof are intended to refer to any gaseous substance known, expected, or suspected to contain analytes. Gas samples can be broadly classified as organic, inorganic, or biological. Gas samples can include a mixture of analytes and non-analytes. The term “analyte” is intended to refer to any component of interest in a gas sample that can be detected according to the present techniques, while the term “non-analyte” is intended to refer to any sample component for which detection is not of interest in a given application. Non-limiting examples of non-analytes include, to name a few, water, oils, solvents, and other media in which analytes may be found, as well as impurities and contaminants. It is appreciated that in some instances, terms such as “component”, “compound”, “constituent”, and “species” may be used interchangeably with the term “analyte”. In some implementations, the analytes of interest may include volatile organic compounds (VOCs). VOCs are organic chemicals that readily produce vapors at ambient temperatures and are therefore emitted as gases from certain solids or liquids. VOCs include both human-made and naturally occurring chemical compounds. Non-limiting examples of VOCs include, to name a few, aromatics, alkenes, bromides and iodides, sulfides and mercaptans, organic amines, ketones, ethers, esters and acrylates, alcohols, aldehydes, and alkanes, and alkyl halides. It is appreciated, however, that the present technique may also be used to detect certain volatile inorganic compounds and semi-volatile organic compounds.

Various embodiments disclosed herein may be used in gas chromatography (GC) applications. In the present description, the term “gas chromatography” refers to an analytical or process technique for separating a gas sample or mixture into its individual components and for analyzing qualitatively and quantitatively the separated sample components. In most GC applications, the sample is transported in a carrier gas to form a mobile phase. The mobile phase is then carried through a stationary phase, which is located in a column or another separation device. The mobile and stationary phases are selected so that the components of the gas sample transported in the mobile phase exhibit different interaction strengths with the stationary phase. This leads to different sample components having different retention times through the system, where the sample components that are strongly interacting with the stationary phase move more slowly with the flow of the mobile phase and elute from the column later than the sample components that are weakly interacting with the stationary phase. As the sample components separate, they elute from the column and enter a detector. The detector is configured to generate an electrical signal whenever the presence of a sample component is detected. The magnitude of the signal is proportional to the concentration level of the detected component. The measurement data can be processed by a computer to obtain a chromatogram, which is a time series of peaks representing the sample components as they elute from the column. The retention time of each peak is indicative of the composition of the corresponding eluting component, while the peak height or area conveys information of the amount or concentration of the eluting component. It is appreciated, however, that various other embodiments disclosed herein may be used in technical fields other than GC. Non-limiting examples of such technical fields include, to name a few, gas purification systems, gas leak detection systems, and online gas analyzers without chromatographic separation.

The present techniques may be used or implemented in various fields that may benefit from reduced or minimal background noise with respect to the analyte to be characterized.

It will be noted that the present description may refer to a “chromatography column” or a “chromatography method”, and that such a chromatography column or method is typically located before of upstream from the chromatography system described herein. The chromatography column or method could include detector(s), valve(s), column(s), analytical system(s), device(s), other chromatographic component(s), and/or any combinations thereof.

### System Implementations

Broadly described, there is provided a system for exciting and ionizing analyte(s) in a sample without ionizing or exciting the non-analyte(s) or the background. The system that will now be described allow eliminating or at least reducing the relatively strong emission generally associated with the non-analyte(s) or background, which can lead to a more precise characterization or measurement of the analytes.

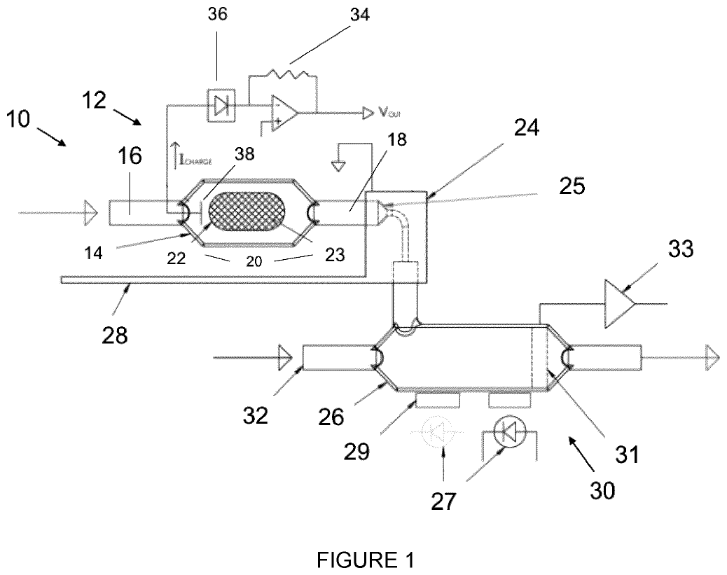

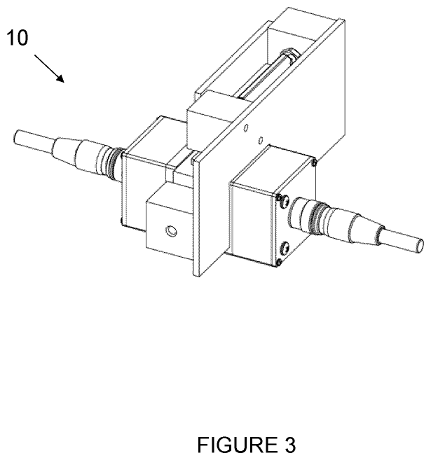

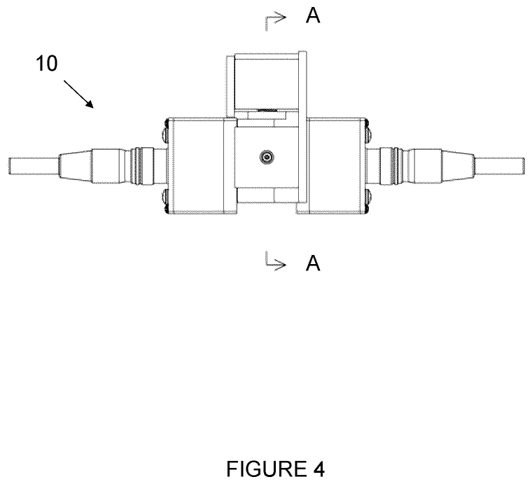

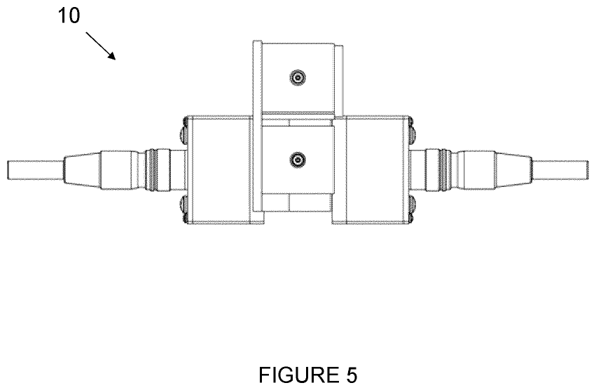

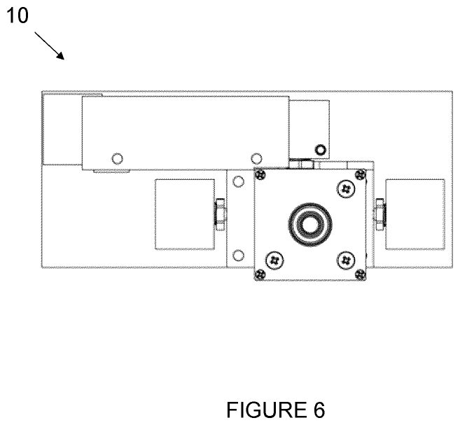

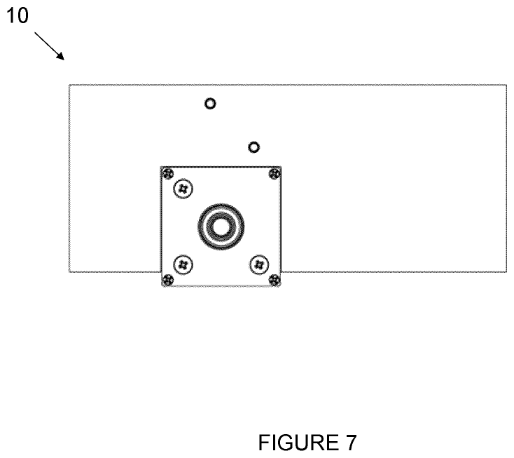

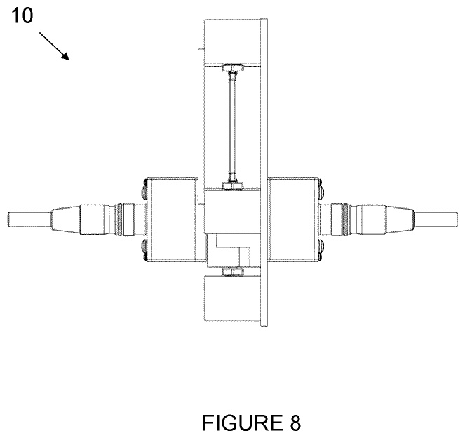

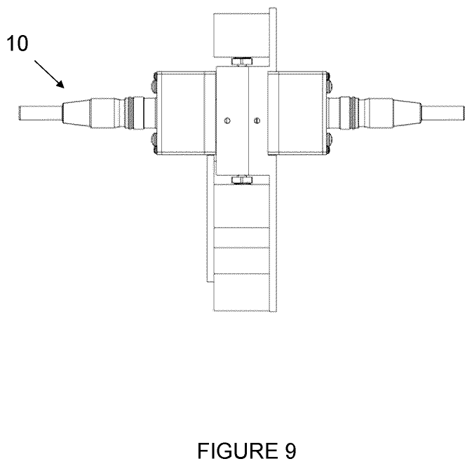

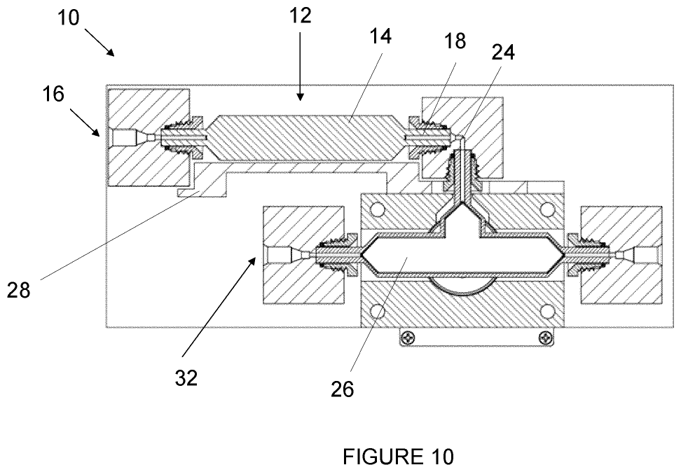

As illustrated in FIGS. 1 to 10, there is provided a system 10 for chromatographically analyzing a sample (referred as the “system 10”). The system 10 includes a metastable species source 12, a measurement chamber 26 and a detector 30. Of note, the expression “metastable species” may refer to metastable atom(s) and/or molecule(s) excited-state species having a relatively long lifetime.

The metastable species source 12 includes a plasma chamber 14, having an inlet 16 and an outlet 18. The inlet 16 is configured to receive therein a gas stream (sometimes referred as a “metastable generating gas”). In some embodiments, the gas stream may be a pure gas. Nonlimitative example of gases include argon, helium, and many others. In some embodiments, the gas may be doped with a reagent or a doping agent. Examples of reagent or doping agent are krypton and xenon. In some embodiments, the concentration of reagent or doping agent is about 2% (with respect to the pure gas also present in the mix). The gas stream flowing in the plasma chamber 14 may be embodied by a non-equilibrium low-power plasma state. In some embodiments, the gas flowing into or through the plasma chamber 14 is a high-purity grade gas containing a relatively low fraction of impurities and may even be embodied by a high-purity gas without impurities. Such a high-purity gas can be generated by or coming out from a gas purifier. The gas purifier may be based on zirconium-alloy technologies or similar approach.

In some embodiments, the plasma chamber 14 is at least partially made of quartz, or any materials or combinations of materials the required properties. In other embodiments, the plasma chamber 14 is entirely made of quartz. In some embodiments, the plasma chamber 14 is made from a plasma-compatible material, such as, alumina or sapphire, to name a few.

The metastable species source 12 also includes a plasma discharge mechanism 20 operatively connected to the plasma chamber 14. The plasma discharge mechanism 20 is configured to excite and ionize impurities present in the gas stream or the metastable generating gas stream to produce or generate a plasma. The plasma includes at least metastable species and electrically-charged species. Plasma typically includes metastable species, positively charged ions, negatively charged ions, electrons, free radicals, chemical species, molecular species, and also produces generates light or at least one optical emission. Of note, the metastable species may be atoms or molecules that are electrically neutral but are in an excited state (i.e., an intermediate energetic state different than a state of least energy).

In some embodiments, the plasma discharge mechanism 20 includes electrodes mounted or attached to the plasma chamber 14. In some embodiments, the plasma discharge mechanism 20 includes two electrodes, labelled 22 and 23 on FIG. 1. The electrodes 22, 23 may be embodied by a pair of flat electrodes (or relatively flat electrodes) positioned in a spaced-apart configuration one from another, for example a respective side or sidewall of the plasma chamber 14. In some embodiments, the electrodes 22, 23 may be made from a metallic material.

The electrodes 22, 23 are operatively connected to a power source or supply (not illustrated in the Figures). It should be noted that the electrodes 22, 23 can be driven according to a driving signal matching or following a specific or predetermined pattern. In some embodiments, the power source can be operated to produce or generate AC high-frequency signal(s), DC pulse(s), continuous sinusoidal waveform(s), square waveforms(s), bipolar DC pulse(s), and the like.

As the gas stream flowing in the plasma chamber 14 is typically a non-equilibrium low-power plasma state with little to no impurities, the plasma generated by the plasma discharge mechanism 20 typically includes charged species, i.e., positive ions, negative ions, free electrons, UV, VIS and NIR emissions, and metastable species.

The metastable species sources 12 also includes a conduit 24 in fluid communication with the outlet 18 of the plasma chamber 14 and configured to receive the plasma therefrom. The conduit 24 includes an electrically-conductive region adapted to receive and trap the electrically-charged species and allow circulation of the metastable species.

As illustrated in FIG. 1, the conduit 24 has the shape of an elbow, i.e., the conduit 24 has two relatively straight segments having a bent segment therebetween. It should be noted that the two relatively straight segments are aligned with an angle of about 90° one with respect to another. This configuration can be useful to prevent light emanating from the plasma generated in the plasma chamber 14 to reach the measurement chamber 26. Still referring to FIG. 1, the conduit has a relatively circular cross-section. It should however be noted that the geometrical configuration of the conduit 24 may be different than the configuration illustrated in the Figures. For example, in some embodiments, the conduit 24 may be S-shaped, or may alternatively have a zigzag profile. The shape, dimensions and geometrical configuration of the conduit 24 are typically optimized or selected to reduce the light transmission to the measurement chamber 26.

The conduit 24 also includes an anodized region to prevent light transmission out of the plasma chamber 14 towards the measurement chamber 26, which may be useful to minimize or at least reduce the interferences that may be caused by the optical emission of the plasma generated in the plasma chamber 14. It should be noted that the anodized region of the conduit 24 are located at different position from the electrically-conductive region, and that each of these regions serve a different purpose. More specifically, the anodized region absorbs the light emitted by the plasma generated in the plasma chamber 14 to reduce or limit its propagation outside of the metastable species sources 12 and the plasma chamber 14, whereas the electrically-conductive region acts as a “trap” or “trapping site” to capture or catch the electrically-charged species contained in the plasma.

In some embodiments, the conduit 24 may be formed in a block made from an anodized material. For example, and without being limitative, the block may be a black anodized aluminum block into which the conduit 24 is formed.

In some embodiments, at least one portion of the conduit 24 may be tapered. In some embodiments, the electrically-conductive region of the conduit 24 may be provided in the tapered section 25. It should be noted that the electrically-conductive region is not anodized, in order to provide electrical conductivity for catching or trapping the electrically-charged species generated or produced in the plasma chamber 14.

As illustrated in FIG. 1, the metastable species source 12 includes one plasma chamber 14 and conduit 24. However, it should be noted that that the metastable species source may include a plurality of plasma chambers, each being associated with a corresponding conduit. Having a plurality of plasma chambers and corresponding conduits allows injecting different metastable species into the measurement chamber 26. The different metastable species may be simultaneously injected into the measurement chamber 26, or may alternatively be sequentially injected (i.e., co-injected) into the measurement chamber 26. Having a plurality of plasma chambers and corresponding conduits also allows injecting the metastable species but using different operating conditions, for example in scenarios in which it may be desirable to control the flow, the timing or other properties of the metastable species' release.

In some embodiments, the metastable species source 12 may rely on another mechanism than a plasma discharge based mechanism, meaning that the metastable species may be generated by another metastable species source, different than the one having been previously described. In some embodiments, the metastable species may be generated using a metal sheet, similar to those used in X-rays based techniques. In some embodiments, the metastable species may be generated using a combination of one or more of: light-induced mechanism, thermal-induced mechanism, pressure-induced mechanism, small radioactive source, and many others.

Now that embodiments of the metastable species source 12 have been presented, the measurement chamber 26 will be described in greater detail. As illustrated in the Figure, the measurement chamber 26 is positioned after or downstream of the plasma chamber 14 and the conduit 24.

In the illustrated embodiments, the measurement chamber 26 has an outer or external surface, and the conduit 24 is substantially perpendicular to the outer or external surface of the measurement chamber 26. It should be noted that the angle formed between the conduit 24 and the outer or external surface of the measurement chamber 26 may be different than 90°. For example, and without being limitative, the angle may be acute or obtuse. The orientation of the conduit 24 with respect to the outer or external surface of the measurement 26 may be optimized or selected based on different parameters, such as the probabilities of collisions between the metastable species and the sample.

In the embodiments wherein the metastable species source 12 includes a plurality of plasma chambers and corresponding conduit, each conduit may be disposed along the circumference or the outer surface of the measurement chamber 26, such that each conduit 24 is radially disposed with respect to the measurement chamber 26.

The measurement chamber 26 is configured to receive the sample from a chromatography method (labelled as “carrier +sample” in FIG. 1), for example through tubing 32 or appropriate chromatographic component(s). As previously mentioned, the sample includes an analyte and a non-analyte, or an analyte portion or component, and a non-analyte portion of components. The measurement chamber 26 is also configured to receive the metastable species, originating from the plasma produced in the plasma chamber 14, after circulation of the plasma in the conduit 24. The interaction between the metastable species and the sample produces an “excited” or/and “ionized” analyte, without exciting or ionizing the non-analyte.

The interaction between the metastable species (e.g., noble gas atom(s)) with other species, which may include atom(s), molecule(s) (diatomic molecule(s) and/or polyatomic molecule(s)), may be associated with one of the following reactions:
Penning Ionization: X*+R→X+R⁺ (or R⁺*)+e⁻
Associative Ionization: X*+R→RX⁺+e⁻
Neutral Excitation: X*+R→X+R*
Neutral Dissociation: X*+R→X+R′+R″
Neutral Dissociative Excitation: X*+R→X+R′*+R″

Of note, the neutral excitation, the neutral dissociation, and the neutral dissociative excitation produce excited states that can be detected and analysed by emission spectroscopy techniques. The reactions which produce ion(s) (negative ion(s) and/or positive ion(s)) can be detected and measured with an electrical or an electronic circuit, which may include an electrometer circuit or similar instrument.

The system 10 typically includes an optical shield 28 (sometimes referred to as a “screen”), disposed between the plasma chamber 14 and the measurement chamber 26. Positioning of the optical shield 28 is such that it minimizes or prevents light transmission from the plasma chamber 14 into the measurement chamber 26, which would interfere with the detector 30 or the measurements made by the detector 30. In addition, at least a portion of the light emission associated with the plasma generated in the plasma chamber 14 could have enough energy to ionize impurities or analyte contained in the sample, which would be problematic, as it would cause causing an interference current into the detector 30.

If the measurement chamber 26 is not properly shielded from the light emitted or emanating from the plasma chamber 14, some metastable species flowing into the measurement chamber 26 could absorb photon(s), which would result in a new metastable state and directly or indirectly radiate to the ground state, similar to a pumping mechanism. Of note, this would lead to a reduction of useful metastable species in the measuring chamber 26, as these newly generated metastable species decay much faster than the other metastable species.

The optical shield 28 may also be useful in preventing or minimizing risks of interferences within the measurement chamber 26, as the light generated by the plasma in the plasma chamber 24 could otherwise generated photoelectrons and/or be received by the detection electrodes (or photoelectrodes), which could result in the ionization thereof, and eventually in their premature degradation.

The detector 30 is configured to obtain a sample chromatogram from the excited or ionized analyte. In some embodiments, the detector 30 is configured to perform an optical detection of the excited analyte, for example using photodiode(s) 27 and optical filter(s) 29. In some embodiments, the detector 30 is configured to perform an electrical detection of the ionized analyte, for example using electrode(s) 31 and electronic amplifier(s) 33 configured to collect the electrical charges generated by the ionized analyte. In some embodiments, the detector 30 is configured to perform both optical and electrical detections. Of note, the optical detection and the electrical detection may be simultaneous or sequential.

Now that each element of the system 10 has been described, the working principle of the whole system 10 will be presented in greater detail. Broadly described, the system 10 detector relies on the generation and use of metastable species from a plasma discharge source to ionize and excite impurities or analytes from a gas sample. When returning to their ground state, the excited species will generate photon emission, while the ionized impurities will generate positive ions and negative charges (generally electrons). The photon emission can be collected using an optical circuit for determining a concentration of the analyte or impurity level. The photon emission generates specific wavelengths allowing impurity species identification, and the intensity of emission is also related to impurity level. The electrical charges can be collected by a polarized electrode generating a current proportional to the impurity level. If the metastable generating gas is the same type as the carrier gas, the carrier gas will not be excited or ionized, and so there will be no background emission (i.e., the background is not excited or ionized). The metastable species are then introduced into the measurement chamber through the conduit and mixed with the carrier and sample gases coming from the chromatography method. When the metastable collides with analytes impurities having a lower excitation and/or ionization energy level, it will excite/ionize the analytes or impurities.

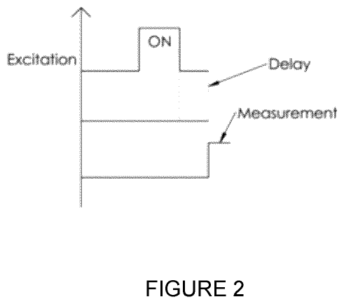

In some embodiments, and with reference to FIG. 2, the measurements or detection of the chromatogram associated with the excited or ionized species, performed by the system 10, may be delayed with respect with the generation or production of the metastable species. For example, the signal used to drive the plasma discharge mechanism may follow a specific pattern, such as a relatively square waveform, thereby alternating between an “ON” state and an “OFF” state over a predetermined period. In the “ON” state, the metastable species source produces metastable species, whereas, in the “OFF” state, the metastable species source does not produce any metastable species. The measurements or detection may begin once the metastable species source is in the “OFF” state, meaning that the measurements or detection of the sample chromatogram from the excited or ionized analyte may be performed after the generation or production of metastable species. As such, the generation of the metastable species and the measurements or detection of the sample chromatogram from the excited or ionized analyte may be performed in a sequential manner.

Of note, timing of the generation of the metastable species and/or detection of the sample may significantly reduce the number of electrical charges or may even eliminate such electrical charges in the measurement chamber 26, as it will be explained in more detail hereinbelow.

### Considerations for the Minimization of Electrical Charges Generation

In some embodiments, it may be desirable to minimize the generation of electrical charges as much as possible. For example, in some applications, it may be an objective to inject as much metastable species as possible in the measurement chamber. The lifetime of the metastable species is relatively longer than the lifetime of ions and electrons (i.e., the electrically-charged species) generated in the plasma chamber. For example, and without being limitative, when argon gas is used as a source for metastable species generation, the metastable lifetime could be as long as 1.3 second. The lifetime of electrical charges generated is much shorter but still long enough to cause some issues, such as reaching the measurement chamber and causing interferences with the signal being generated from the actual impurities or analytes. Of note, this phenomenon tends to increase when the operating pressure is decreased within the system.

One strategy for limiting the introduction of electrical charges into the measurement chamber is reducing the gas flow. However, doing so also reduces, to some extent, the number of metastable species reaching the measurement chamber. When the probability of having metastable species hitting a wall increases, more of them are being de-excited and transfer their energy to the material forming the wall of the measurement chamber, which can in turn results in the release of electrons, atoms, and/or radicals. For example, and without being limitative, a possible by-product of metastable species colliding a wall made of quartz is oxygen.

Reducing the operating pressure of the system typically improves metastable species generation, because it generally reduces such problematic collisions. However, doing so also increases the number of electrical charges reaching the measurement chamber.

Considering the above, it is possible to balance, tune or find operating conditions that would be optimal for the sample being characterized, i.e., having minimal or no electrical charges reaching the measurement chamber. This can be achieved with an electrometer made of an amplifier 34, a bias power supply 36, a first electrical collecting electrode 38, and a second electrode, which may be embodied by the non-anodized portion or section 25 of the black anodized aluminum block 24.

The system having been herein described allows a current measurement proportional to the electrical charges generated by the metastable species source, because the output voltage is proportional to those charges. By monitoring the output voltage for a minimum value, while adjusting the gas flow and pressure of the system, it is possible to determine a point or a set of points in the operating condition at which there will be no charge reaching the measurement chamber. When the minimum output voltage is reached, the plasma intensity can also be adjusted to further reduce the electrical charge interference.

### Method Implementations

A method for chromatographically analyzing a sample will now be described.

The method includes a step of generating, in a plasma chamber, a plasma in a gas stream. In some embodiments, the plasma chamber may be similar to one of the embodiments of the plasma chamber having been previously described. The plasma includes at least metastable species and electrically-charged species. Of note, the plasma may include negatively-charged species, positively-charged species. The plasma also produces optical emissions, and the spectral profile of the optical emissions depends on the species contained in the plasma.

The method includes a step of circulating the gas coming out of the plasma chamber in a conduit comprising an electrically-conductive region adapted to receive the electrically-charged species and allow circulation of the metastable species. In some embodiments, the conduit may be similar to one of the embodiments of the conduit having been previously described.

The method includes a step of injecting the sample in a measurement chamber, the sample comprising an analyte and a non-analyte.

The method includes a step of injecting the metastable species in the measurement chamber, wherein an interaction between the metastable species and the sample produces an excited or ionized analyte, without exciting or ionizing the non-analyte. Of note, the injection of the sample and the metastable may be simultaneous or not.

The method also includes a step of obtaining a sample chromatogram from the excited or ionized analyte. This step may be achieved using one of the embodiments of the detector having been previously described.

### Examples of an Implementation

Now that embodiments of the technology have been described, an example of a detector will be presented.

The system includes a metastable source. This source is made of a quartz chamber having on each side a flat metallic electrode. These electrodes are connected to a power source that could produce or generate bursts of AC high-frequency signal, DC pulses, continuous sinewave or square wave signal, or bipolar DC pulses.

The gas flowing into this chamber can be under a non-equilibrium low-power plasma state. The plasma generates charged species, positive ions, negative ions, free electrons, UV emission, VIS emission, NIR emission, and metastable species.

The gas flowing into this chamber is a high-purity grade without impurities, generally coming from a gas purifier based on zirconium alloy.

The chamber could be made of other plasma-compatible materials, like alumina, sapphire, and similar materials.

The outlet tube of the chamber is connected to a black anodized aluminum elbow block to minimize light transmission into the measuring chamber, which could interfere with the light measuring photodiodes. Also, some of this photon emission may have enough energy to ionize impurities causing an interference current into ion current measuring electrodes.

The black anodized block has a tapered section that does not have its surface anodized in order to provide electrical conductivity for catching charged species, generated from the metastable cell.

The 90° elbow section of the block is configured, positioned and shape to prevent light from the plasma cell to reach the measuring cell. The elbow internal conduit may also have an “S” or zigzag shape, reducing, even more, the light transmission to the measuring cell. There is also a light-shielding wall preventing interference if the cell is made of transparent material.

The metastable is then introduced into the measuring or detecting cell through the tubing and mixed with the carrier and sample gases coming from the tube. When the metastable collides with impurities having a lower excitation and/or ionization energy level, it will excite/ionize them.

The excited impurities will release photon emissions at a specific wavelength that are measured through an optical filter and photodiode. The ionized impurities generate electrical charges that are collected through electrodes and amplified by an electronic amplifier (e.g., the amplifier 33).

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the present disclosure and appended claims.

1. A system for chromatographically analyzing a sample, the system comprising:
a metastable species source, the metastable species source comprising:
a plasma chamber having an inlet and an outlet, the inlet being configured to receive a gas stream;
a plasma discharge mechanism configured to produce a plasma from the gas stream circulating in the plasma chamber, the plasma comprising at least metastable species and electrically-charged species; and
a conduit in fluid communication with the outlet of the plasma chamber and adapted to receive the gas from the plasma chamber, the conduit comprising an electrically-conductive region configured to trap the electrically-charged species and allow circulation of the metastable species;
a measurement chamber configured to:
receive the sample from a chromatography method, the sample comprising an analyte and a non-analyte; and
receive the metastable species after circulation of the gas from the plasma chamber in the conduit, wherein an interaction between the metastable species and the sample produces an excited or ionized analyte, without exciting or ionizing the non-analyte; and
a detector configured to obtain a sample chromatogram from the excited or ionized analyte.

2. The system of claim 1, wherein the gas stream contains a pure gas.

3. The system of claim 1, wherein the gas stream is doped with a reagent or a doping agent.

4. (canceled)

5. The system of claim 1, wherein the plasma discharge mechanism comprises two electrodes.

6. (canceled)

7. (canceled)

8. The system of claim 1, wherein the conduit comprises a first segment and a second segment, the first segment forming an angle of about 90° with the second segment.

9. The system of claim 1, wherein the conduit comprises a first segment, a second segment, and a bent segment therebetween.

10. (canceled)

11. (canceled)

12. (canceled)

13. The system of claim 1, wherein the conduit further includes an anodized region to prevent light transmission out of the plasma chamber towards the measurement chamber, the anodized region being located at a different position from the electrically-conductive region.

14. The system of claim 1, wherein at least one portion of the conduit is tapered.

15. The system of claim 14, wherein the electrically-conductive region of the conduit is provided in said at least one portion of the conduit being tapered.

16. The system of claim 1, wherein the metastable species source comprises a plurality of plasma chambers, each having a corresponding conduit disposed along an outer surface of the measurement chamber, such that each conduit is radially disposed with respect to the measurement chamber.

17. The system of claim 16, wherein the conduit is substantially perpendicular to the outer surface of the measurement chamber.

18. The system of claim 1, further comprising an optical shield disposed between the plasma chamber and the measurement chamber.

19. The system of claim 1, wherein the detector is configured to perform an optical detection of the excited or ionized analyte.

20. The system of claim 1, wherein the detector is configured to perform an electrical detection of the excited or ionized analyte.

21. The system of claim 1, wherein the detector is configured to perform both an optical detection and an electrical detection of the excited or ionized analyte.

22. The system of claim 21, wherein the optical detection and the electrical detection are simultaneously performed.

23. The system of claim 21, wherein the optical detection and the electrical detection are sequentially performed.

24. The system of claim 1, wherein obtaining the sample chromatogram associated with the excited or ionized analyte is delayed with respect with generating the metastable species.

25. A method for chromatographically analyzing a sample, the method comprising:
in a plasma chamber, generating a plasma in a gas stream, the plasma comprising at least metastable species and electrically-charged species;
circulating the plasma in a conduit comprising an electrically-conductive region adapted to receive and trap the electrically-charged species and allow circulation of the metastable species;
injecting the sample in a measurement chamber, the sample comprising an analyte and a non-analyte;
injecting the metastable species in the measurement chamber, wherein an interaction between the metastable species and the sample produces an excited or ionized analyte, without exciting or ionizing the non-analyte; and
obtaining a sample chromatogram from the excited or ionized analyte.

26. (canceled)

27. (canceled)

28. (canceled)

29. (canceled)

30. (canceled)

31. (canceled)

32. (canceled)

33. The method of claim 25, wherein said obtaining the sample chromatogram associated with the excited or ionized analyte is delayed with respect with generating the metastable species.

34. (canceled)
